(19) United States
(12) Patent Application Publication
(10) Pub. No.: US 2014/0054217 A1
(43) Pub. Date: Feb. 27, 2014

(54) WASTEWATER AERATION

(71) Applicant: TICONA LLC, Florence, KY (US)

(72) Inventors: Meinhard Gusik, Oberhausen (DE); Julia Hufen, Rheinberg (DE); Ludger Czyborra, Kronberg (DE); Janine Bauer, Duisburg (DE)

(73) Assignee: TICONA LLC, Florence, KY (US)

(21) Appl. No.: 13/974,111

(22) Filed: Aug. 23, 2013

Related U.S. Application Data
(60) Provisional application No. 61/692,539, filed on Aug. 23, 2012.

(51) Int. Cl. C02F 3/20

(52) U.S. Cl. CPC C02F 3/201
USPC 210/600

(57) ABSTRACT

A process for the aeration of wastewater employs an aerator comprising a porous body having an average pore size from 5 to 250 μm produced by sintering a composition comprising polyethylene particles having a molecular weight of at least 3×10⁵ g/mol as determined by ASTM-D 4020 and a weight average particle size, D₅₀, from 20 to 650 μm. The porous aerator is provided in the wastewater and an oxygen-containing gas, such as air, is passed through the porous aerator into the wastewater to assist in purification of the wastewater.

### CROSS REFERENCE TO RELATED APPLICATIONS

This application claims the benefit of the filing date of U.S. Provisional Application No. 61/692,539 filed Aug. 23, 2012, the entire contents of which are incorporated herein by reference.

### FIELD

The present invention relates to wastewater aeration.

### BACKGROUND

Aeration is a process for breaking down wastewater using microorganisms and vigorous agitation. The microorganisms function by coming into close contact with and decaying the dissolved and suspended organic matter in the wastewater. The microorganisms are kept alive by oxygen in air that is bubbled through the wastewater using aerators or porous diffusers generally mounted on the bottom and sometimes the sides of an aeration tank. Currently, aerators are produced from ceramic materials, such as alumina, aluminum silicates and silica; elastomeric materials, such as EPDM; and thermoplastic materials, such as high density polyethylene (HDPE) and polyurethane.

Ceramic aerators suffer from the problem that they are relatively brittle and hence easily breakable. Ceramic materials also tend to have a rough surface, on which deposits and incrustations can easily form, which then causes blockages of the aerator. This increases the energy costs associated with the use of ceramic aerators.

Elastomeric aerators frequently require significant air pressure before their pore structure will allow passage of air into the wastewater. Again, this increases energy costs. Furthermore, elastomeric aerators are normally made of EPDM rubber, which is not chemically resistant to all types of sewage.

With aerators made of HDPE, the thermoplastic polymer must be ground into a powder and then sintered to produce the porous structure required for aeration. However, it is difficult to exert close control over the particle size produced by grinding, which in turn limits the ability to control the pore size of the aerator and hence the bubble size of the air bubbles generated when the aerator is used in wastewater treatment.

There is therefore a need for improved aerators for use in the treatment of wastewater.

According to the present invention, it has now been found that, when polymerized in powder form having a weight average particle size, D₅₀, between 20 and 650 μm, high, very-high and ultra-high molecular weight polyethylene can be sintered to produce wastewater aerators which have closely controlled and reproducible pore sizes and which allow effective aeration even at low air pressure. In this respect, high molecular weight polyethylene (HMWPE) is defined herein as having a molecular weight of at least 3×10⁵ g/mol and less 1×10⁶ g/mol as determined by ASTM 4020, very-high molecular weight polyethylene (VHMWPE) is defined herein as having a molecular weight of at least 1×10⁶ g/mol and less 3×10⁶ g/mol as determined by ASTM 4020, and ultra-high molecular weight polyethylene (UHMWPE) is defined herein as having a molecular weight of at least 3×10⁶ g/mol as determined by ASTM 4020.

### SUMMARY

In one aspect, the invention resides in a process for the aeration of wastewater, the process comprising:

(a) providing a porous aerator in the wastewater; and

(b) passing an oxygen-containing gas, such as air, through the porous aerator into the wastewater,

wherein the aerator comprises a porous body produced by sintering a composition comprising polyethylene particles having a molecular weight of at least 3×10⁵ g/mol as determined by ASTM-D 4020 and a weight average particle size, D₅₀, from 20 to 650 μm and wherein the porous body has an average pore size from 5 to 250 μm.

Generally, the polyethylene particles have a molecular weight up to 10×10⁶ g/mol, such as from 6×10⁵ g/mol to 5×10⁶ g/mol, as determined by ASTM-D 4020.

Typically, the polyethylene particles have a weight average particle size, D₅₀, from 30 to 450 μm.

In one embodiment, the polyethylene particles have a bulk density from 0.1 to 0.5 g/ml.

Generally, said composition comprises at least 90 wt % of said polyethylene particles.

Typically, the porous body has a porosity of at least 30%, an average pore size of between 5 and 250 μm and a pressure drop less than 80 mbar.

Conveniently, the porous body comprises pores of substantially uniform size.

### BRIEF DESCRIPTION OF THE DRAWINGS

FIG. 1 is a graph of pressure drop against air flow for aerators produced from different HMWPE, UHMWPE, elastomeric and ceramic materials as described in Example 1.

FIG. 2 is a graph of specific standard oxygen transfer rate (SSOTR) against specific air flow for the different aerators produced in Example 1.

FIG. 3 is a graph of Standard Aeration Efficiency (SAE) against specific air flow per m³ water volume for the different aerators produced in Example 1

### DETAILED DESCRIPTION OF THE EMBODIMENTS

Described herein is an aerator for bubbling an oxygen-containing gas, such as air, into wastewater to assist in the decomposition of dissolved and suspended organic matter in the wastewater and hence in purification of the wastewater.

The aerator comprises a porous body which is produced by sintering a composition comprising polyethylene particles having a molecular weight of at least 3×10⁵ g/mol, such as up to 10×10⁶ g/mol, typically from 6×10⁵ g/mol to 5×10⁶ g/mol, all as determined by ASTM-D 4020. The polyethylene powder may have a monomodal molecular weight distribution or may have a multimodal, generally bimodal, molecular weight distribution.

The polyethylene particles used to produce the present aerator have a weight average particle size, D₅₀, from 20 to 650 μm, for example from 30 to 450 μm, such as from 50 to 350 μm, and in some embodiments from 50 to 250 μm. Preferably, the as-synthesized polymer has the desired particle size. However, if the as-synthesized polymer has a particle size in excess of the desired value, the particles can be ground to the desired particle size. The bulk density of the polyethylene powder is typically from 0.1 to 0.5 g/ml, such as from 0.2 to 0.45 g/ml.

The high molecular weight polyethylene powder used to produce the aerator body is typically produced by the catalytic polymerization of ethylene monomer or ethylene-1-olefin co-monomers, the 1-olefin content in the final polymer being less or equal to 10% of the ethylene content, with a heterogeneous catalyst and an organo aluminum- or magnesium compound as cocatalyst. The ethylene is usually polymerized in the gas phase or slurry phase at relatively low temperatures and pressures. The polymerization reaction may be carried out at a temperature from 50° C. to 100° C. and pressures in the range from 0.02 to 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid wall fouling and product contamination.

Suitable catalyst systems include, but are not limited to, Ziegler-Natta type catalysts. Typically Ziegler-Natta type catalysts are derived by a combination of transition metal compounds of Groups 4 to 8 of the Periodic Table and alkyl- or hydrid derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum- or magnesium compounds, such as for example aluminum- or magnesium alkyls and titanium-, vanadium- or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system can be obtained by the reaction of a titanium(IV) compound with a trialkyl aluminum compound in an inert organic solvent at temperatures in the range of −40° C. to 100° C., preferably −20° C. to 50° C. The concentrations of the starting materials are in the range of 0.1 to 9 mol/l, preferably 0.2 to 5 mol/l, for the titanium(IV) compound and in the range of 0.01 and 1 mol/l, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium(IV) compound with a trialkyl aluminum compound in an inert organic solvent at temperatures in the range of −40° C. to 200° C., preferably −20° C. to 150° C. In the first step the titanium(IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/l, preferably 5 to 9.1 mol/l, for the titanium(IV) compound and in the range of 0.05 and 1 mol/l, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100° C. In a second reaction stage, the reaction mixture formed in the first stage is subjected to heat treatment for a period of about 10 to 100 hours at a temperature of 110° to 200° C. accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917, can also be used.

Using such catalyst systems, the polymerization is normally carried out in suspension at low pressure and temperature in one or multiple steps, continuous or batch. The polymerization temperature is typically in the range of 30° C. to 130° C., preferably is the range of 50° C. and 90° C. and the ethylene partial pressure is typically less than 10 MPa, preferably 0.05 and 5 MPa. Trialkyl aluminums, such as isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples include butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium-magnesium and zinc stearate.

Optionally, other catalysts such as Phillips catalysts, metallocenes and post metallocenes may be employed. Generally a cocatalyst such as alumoxane or alkyl aluminum or alkyl magnesium compound is also employed. For example, U.S. Patent Application Publication No. 2002/0040113 to Fritzsche et al., the entire contents of which are incorporated herein by reference, discusses several catalyst systems for producing ultra-high molecular weight polyethylene. Other suitable catalyst systems include Group 4 metal complexes of phenolate ether ligands such as are described in International Patent Publication No. WO2012/004675, the entire contents of which are incorporated herein by reference.

The resultant high molecular weight polyethylene powder is formed into the required porous aerator body by molding, with additional materials optionally being added to the molding composition, depending on the desired properties of the molded article. The powder may also contain additives such as lubricants, dyes, pigments, antioxidants, antimicrobials, fillers, processing aids, light stabilizers, neutralizers, antiblocks, and the like. Generally, the molding composition contains at least 90 wt % of the polyethylene particles having a molecular weight of at least 3×10⁵ g/mol as determined by ASTM-D 4020 and a weight average particle size, D₅₀, between 20 and 650 μm.

The molded body may be formed by a free sintering process which involves introducing the molding composition into either a partially or totally confined space, e.g., a mold, and subjecting the molding powder to heat sufficient to cause the polyethylene particles to soften, expand and contact one another. Suitable processes include compression molding and casting. The mold can be made of steel, aluminum or other metals.

Sintering processes are well-known in the art. The mold is heated to the sintering temperature, which is normally in the range of about 100° C. to 300° C., such as 140° C. to 300° C., for example 140° C. to 240° C. The mold is typically heated in a convection oven, hydraulic press or by infrared heaters. The heating time will vary depending on the mass of the mold and the geometry of the molded article. Typical heating times will lie within the range of about 5 to about 300 minutes, more typically in the range of about 15 minutes to about 100 minutes. The mold may also be vibrated to ensure uniform distribution of the powder.

During sintering, the surface of individual polymer particles fuse at their contact points forming a porous structure. The polymer particles coalesce together at the contact points due to the diffusion of polymer chains across the interface of the particles. The interface eventually disappears and mechanical strength at the interface develops. Subsequently, the mold is cooled and the porous article removed. The cooling step may be accomplished by conventional means, for example it may be performed by blowing air past the article or the mold, or contacting the mold with a cold fluid. Upon cooling, the polyethylene typically undergoes a reduction in bulk volume. This is commonly referred to as “shrinkage.” A high degree of shrinkage is generally not desirable as it can cause shape distortion in the final product.

Pressure may be applied during the sintering process, if desired. However, subjecting the particles to pressure causes them to rearrange and deform at their contact points until the material is compressed and the pore size and porosity are reduced.

Typically, the sintering process produces a porous body having an average pore size from 5 μm to 250 μm, such as from 20 μm to 210 μm. In one embodiment, the body has a substantially constant pore size both in and perpendicular to the direction of the flow of oxygen-containing gas through the body.

Generally, the porous body should have a high porosity, such as at least 30% and preferably at least 35%, and a low pressure drop, such as less than 80 mbar, for example less than 50 mbar. Except where indicated in the Examples, pressure drop values cited herein are measured using a sample of the porous article having a diameter of 140 mm, a thickness of 6.2-6.5 mm (depending on shrinkage) and an airflow rate of 7.5 m³/hour and measuring the drop in pressure across the thickness of the sample.

In general the porous body should have a flexural strength at determined in accordance with DIN ISO 178 of at least 0.3 MPa.

Aerator bodies of any shape, such as plate-like, disc-like or tube-like, can be produced using the sintering process described above. In addition, the pore size of the resultant aerator bodies can be precisely controlled by varying the particle size of the polyethylene employed. This is important since the pore size of the aerator influences the bubble size of the air that goes into the waste water. This in turn controls the oxygen uptake of the water as the bubble size has an influence on the residence time of the bubble in the water and how much oxygen is transferred. Moreover, the present aerators are less sensitive to the clogging issues encountered with many conventional aerators in that particulate matter present in the waste water is unable to flow back through the aerator when the air flow is terminated.

The invention will now be more particularly described with reference to the following non-limiting Examples and the accompanying drawings.

In the Examples, and the remainder of the specification, the following tests are used to measure the various parameters cited herein.

Particle size measurements are weight averaged values and are obtained by a laser diffraction method according to ISO 13320.

Polyethylene powder bulk density measurements are obtained according to DIN 53466.

Porosity values are determined by mercury intrusion porosimetry according to DIN 66133.

Average pore size values are determined according to DIN 66133.

Specific Standard Oxygen Transfer Rate (SSOTR) and Standard Aeration Efficiency (SAE) are determined according to DIN EN 12255-15. SSOTR indicates how much oxygen [g] is dissolved in clean water per standard cubic meter [Nm³] of air blown into a water bath per meter [m] of immersion depth of the aerator in the water [m]. The units of SSOTR are therefore g/(Nm³*m). SAE is a measure of the amount of oxygen [kg] that is fed under standard conditions (T=20° C., p=1013 hPa) into a bath filled with clean water per kilowatt hour [kWh]. The units of SAE are therefore kg/kWh.

### EXAMPLE 1

Four commercially-available UHMWPE resin powders and a commercially-available HMWPE resin powder were used to produce sintered aerator bodies with a range of pore size, porosity and pressure drop values as listed in Table 1.

TABLE 1

| | MW × 10⁶, | | Bulk | Pore Size | Lab Pressure |
|---|---|---|---|---|---|
| Resin | g/ml | d50, μm | Density | (BP), μm | Drop, mbar |
| Material 1 | 5 | 120 | 0.45 | 25 | 34 |
| Material 2 | 4 | 130 | 0.23 | 50 | 8 |
| Material 3 | 4 | 330 | 0.45 | 60 | 7 |
| Material 4 | 0.6 | 451 | 0.35 | 205 | 1 |
| Material 5 | 8.1 | 65 | 0.45 | 15 | 75 |

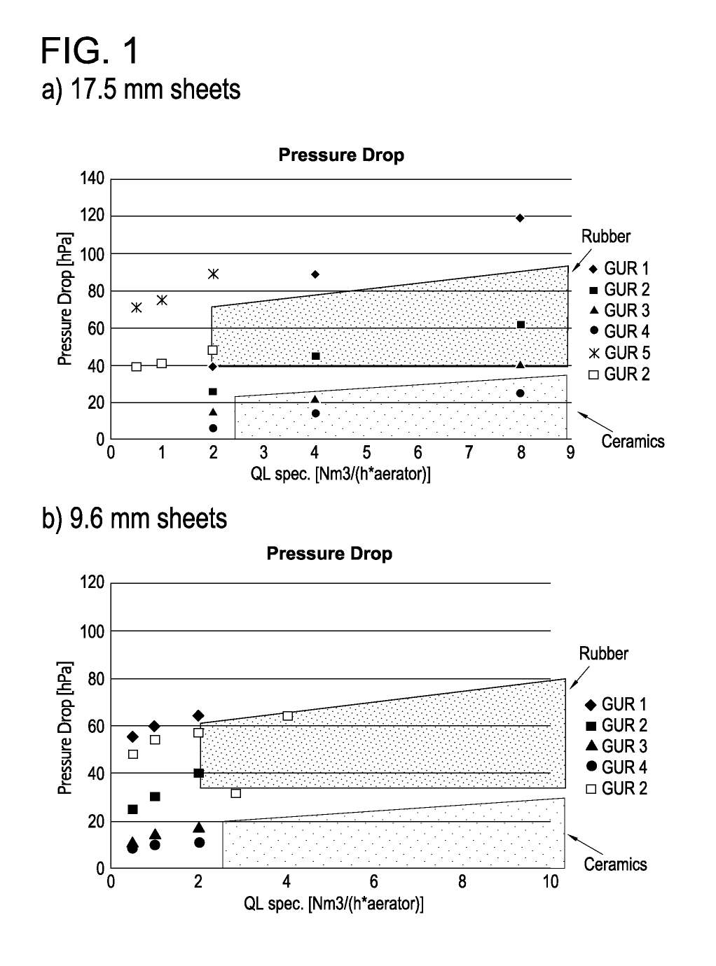

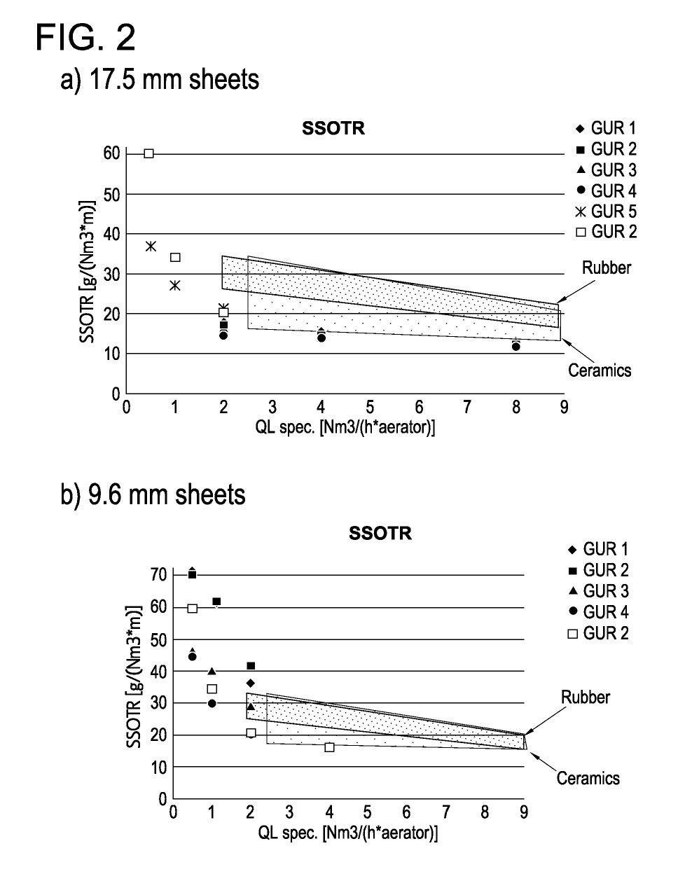

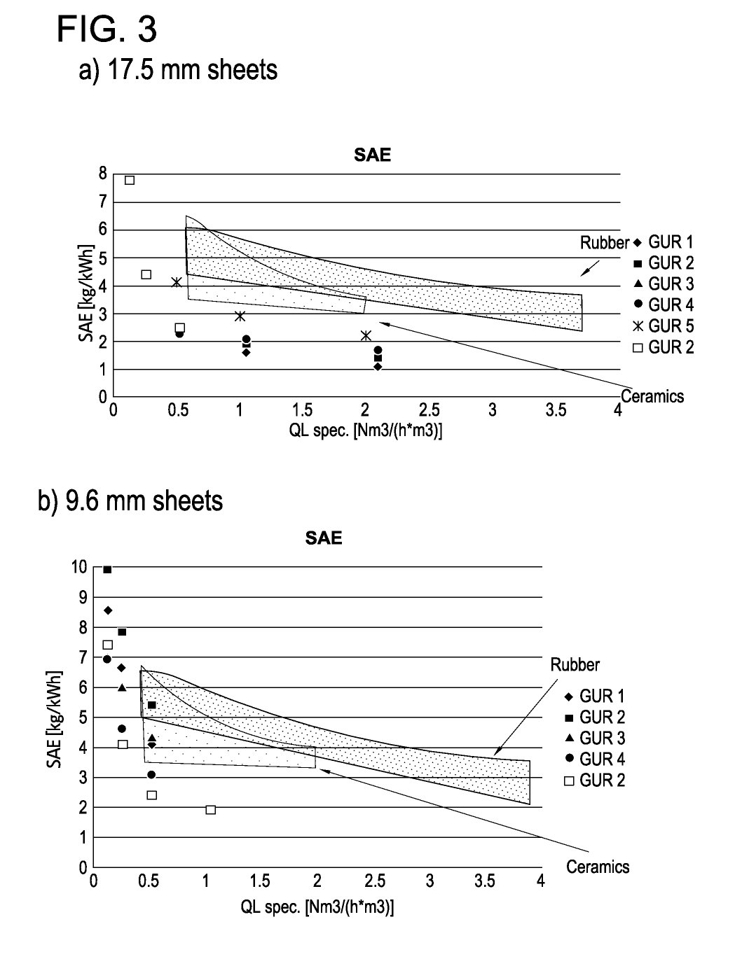

HMWPE and UHMWPE aerator sheets having thickness of 9.6 mm and 17.5 mm were produced from each of the materials listed in Table 1 and their properties compared with similar aerator sheets made from EPDM and a ceramic material. Measurements of the Specific Standard Oxygen Transfer Rate (SSOTR), Standard Aeration Efficiency (SAE) and pressure drop of the aerators were carried out in pure water. Pressure drop values of the tested aerators were obtained by subtracting the pressure at the blow-in depth from the pressure measured at the aeration element. The results are summarized in FIGS. 1 to 3, from which it will be seen that the aerators produced from the different HMWPE and UHMWPE materials exhibited a comparable pressure drop. However, the HMWPE and UHMWPE aerators required less air pressure to achieve the same level of oxygen in the water, thereby employing less energy to achieve equivalent water purification, as compared with the comparison aerators.

1. A process for the aeration of wastewater, the process comprising:
(a) providing a porous aerator in the wastewater; and
(b) passing an oxygen-containing gas through the porous aerator into the wastewater,
wherein the aerator comprises a porous body produced by sintering a composition comprising polyethylene particles having a molecular weight of at least 3×10⁵ g/mol as determined by ASTM-D 4020 and a weight average particle size, D₅₀, from 20 to 650 μm and wherein the porous body has an average pore size from 5 to 250 μm.

2. The process of claim 1, wherein the polyethylene particles have a molecular weight up to 10×10⁶ g/mol as determined by ASTM-D 4020.

3. The process of claim 1, wherein the polyethylene particles have a molecular weight from 6×10⁵ g/mol to 5×10⁶ g/mol as determined by ASTM-D 4020.

4. The process of claim 1, wherein the polyethylene particles have a weight average particle size, D₅₀, from 30 to 450 μm.

5. The process of claim 1, wherein the polyethylene particles have a weight average particle size, D₅₀, from 50 to 350 μm.

6. The process of claim 1, wherein the polyethylene particles have a bulk density from 0.1 to 0.5 g/ml.

7. The process of claim 1, wherein said composition comprises at least 90 wt % of said polyethylene particles.

8. The process of claim 1, wherein the porous body has a porosity of at least 35%.

9. The process of claim 1, wherein the porous body has a pressure drop of less than 80 mbar.

10. The process of claim 1, wherein the porous body has a substantially uniform pore size distribution.

11. The process of claim 1, wherein the aerator achieves a specific standard oxygen transfer rate (SSOTR) in excess of 10 g/(Nm³*m) at an air flow rate between 0.5 and 8 standard cubic meter/hour.

12. The process of claim 1, wherein the aerator achieves a Standard Aeration Efficiency (SAE) in excess of 1 kg/kWh at an air flow rate between 0.1 and 2.5 standard cubic meter/hour.
